(19) United States
(12) Patent Application Publication
(10) Pub. No.: US 2009/0181274 A1
(43) Pub. Date: Jul. 16, 2009

(54) Electrodes for Lanthanum Gallate Electrolyte-Based Electrochemical Systems

(76) Inventors: S. Elangovan, South Jordan, UT (US); Joseph J. Hartvigsen, Kaysville, UT (US)

Correspondence Address: CERAMATEC, INC., 2425 SOUTH 900 WEST, SALT LAKE CITY, UT, 84119, US

(21) Appl. No.: 11/954,088

(22) Filed: Dec. 11, 2007

Related U.S. Application Data
(60) Provisional application No. 60/869,709, filed on Dec. 12, 2006.

(51) Int. Cl. H01M 8/10; H01M 4/00; H01M 8/14

(52) U.S. Cl. 429/30; 429/33; 429/44; 429/46

(57) ABSTRACT

An electrochemical cell is disclosed in one embodiment of the invention as including an oxygen electrode and a solid oxide electrolyte coupled to the oxygen electrode to transport oxygen ions. A hydrogen electrode is coupled to the solid oxide electrolyte and contains nickel combined with a material tending to reduce the reactivity of the nickel with the solid oxide electrolyte. In selected embodiments, the solid oxide electrolyte is lanthanum gallate. Similarly, the material combined with the nickel may be an oxide such as magnesium oxide.

### RELATED APPLICATIONS

This application claims priority to U.S. Provisional Patent No. 60/869,709 filed on Dec. 12, 2006 and entitled ELECTRODES FOR LANTHANUM GALLATE ELECTROLYTE-BASED ELECTROCHEMICAL SYSTEMS.

### BACKGROUND OF THE INVENTION

1. Field of the Invention

This invention relates to electrochemical cells and more particularly to electrodes for lanthanum gallate electrolyte-based electrochemical cells.

2. Description of the Related Art

The benefits of lowering the operating temperature of solid oxide fuel cells (SOFCs) are well recognized. Some of these benefits include: improvement in long-term stability by slowing physical and chemical changes in the cell materials, lower cost systems due to the ability to use smaller heat exchangers made from low cost materials, compatibility with hydrocarbon reformation processes allowing partial internal reformation which further reduces the heat exchanger duty, and finally the potential to improve thermal cycle capability. In addition, the lower operating temperature also facilitates the use of inexpensive stainless steel interconnects. A temperature range of 650° C. to 700° C. is ideally suited to derive the performance stability, system integration, and cost benefits identified above.

In order to derive the advantages of lower operating temperatures, two factors that limit SOFC cell performance, namely the electrolyte resistance and electrode polarization, must be addressed. Conventional SOFCs using yttria-doped zirconia (YSZ) as the electrolyte have been shown to perform at high power densities at 800° C. in anode-supported thin film configurations. Reducing operating temperatures below 800° C. has posed a considerable challenge due to the increased losses that occur at the cathode/electrolyte interface.

Lanthanum gallate compositions provide one potential solution for use as electrolytes in lower temperature SOFCs. These compositions have shown to have high oxygen-ion conductivity over a wide range of temperatures when doped with Sr and Mg. Unlike other oxygen-ion conductors such as ceria and bismuth oxide, Sr- and Mg-doped lanthanum gallate (LSGM) compositions are stable over the oxygen partial pressure range of interest. The combination of stability in low pO₂ and the high oxygen-ion conductivity with a transference number close to unity makes LSGM materials a promising choice for reducing SOFC temperature. Furthermore, LSGM electrolytes have the advantage that they are compatible with Co-based perovskites, which provide effective cathode materials. However, various challenges in the development of anode materials and cell fabrication processes still need to be addressed to effectively make use of LSGM electrolytes.

For example, nickel-based cermets appear to provide the best anode materials for essentially all SOFCs that have been investigated to date. However, the incompatibility of nickel-based anodes with LSGM electrolytes is well known. Specifically, an undesirable interfacial reaction occurs when nickel from the anode diffuses into the LSGM electrolyte, where it reacts to form LaNiO₃. This reaction product has reduced conductivity and significantly degrades SOFC performance. Although a ceria interlayer between the nickel anode and the LS GM electrolyte appears to improve initial performance as well as extend cell life, a catastrophic drop in cell performance has been shown to occur at about 1,200 hours of operation. While an obvious explanation is that the ceria interlayer does not entirely prevent nickel diffusion into the electrolyte, it may also be possible that the ceria/LSGM interface itself is not conducive to long-term stability. Thus, alternative anode materials are needed to take advantage of the high performance potential of LS GM electrolytes in fuel cell (and electrolyzer cell) applications.

In view of the foregoing, what are needed are improved hydrogen electrode materials for use with LSGM electrolytes in solid oxide fuel cell and electrolyzer cell applications. Ideally, the hydrogen electrode material would take advantage of the conductive and catalytic properties of nickel while mitigating the incompatibility between nickel and LSGM compositions. Further needed are improved methods for fabricating electrochemical cells using LSGM electrolytes and nickel-based hydrogen electrodes.

### SUMMARY OF THE INVENTION

The present invention has been developed in response to the present state of the art, and in particular, in response to the problems and needs in the art that have not yet been fully solved by currently available solid oxide electrochemical cells. Accordingly, the present invention has been developed to provide improved hydrogen electrode materials for LSGM-based electrolytes. The features and advantages of the present invention will become more fully apparent from the following description and appended claims, or may be learned by practice of the invention as set forth hereinafter.

Consistent with the foregoing and in accordance with the invention as embodied and broadly described herein, an electrochemical cell is disclosed in one embodiment of the invention as including an oxygen electrode and a solid oxide electrolyte coupled to the oxygen electrode to transport oxygen ions. A hydrogen electrode is coupled to the solid oxide electrolyte and contains nickel combined with a material tending to reduce the reactivity of the nickel with the solid oxide electrolyte.

In selected embodiments, the solid oxide electrolyte is lanthanum gallate. In certain embodiments, the material combined with the nickel is an oxide, such as magnesium oxide. Where the oxide is magnesium oxide, in selected embodiments, the molar ratio of nickel to magnesium oxide is between about 99:1 and 70:30. In selected embodiments, the nickel and magnesium oxide form a solid solution. In other embodiments, the material combined with the nickel includes one or more of copper, copper magnesium oxide, and copper oxide. In selected embodiments, a ceramic such as ceria may also be included in the hydrogen electrode.

In another aspect of the invention, an electrochemical cell in accordance with the invention includes an oxygen electrode and a lanthanum gallate electrolyte coupled to the oxygen electrode to transport oxygen ions. A hydrogen electrode is coupled to the lanthanum gallate electrolyte. The hydrogen electrode contains nickel and magnesium oxide dispersed through the nickel to reduce the reactivity of the nickel with the lanthanum gallate electrolyte.

In another aspect of the invention, a method in accordance with the invention includes providing a solid oxide electrolyte and coupling a solid solution of nickel oxide and an additional oxide to the solid oxide electrolyte. The additional oxide may include an oxide such as magnesium oxide, copper oxide, or copper magnesium oxide. The nickel oxide is then reduced to nickel, leaving the additional oxide in oxide form. The metallic nickel's tendency to react with the solid oxide electrolyte is diminished by the additional oxide.

In yet another aspect of the invention, an electrochemical cell in accordance with the invention includes a lanthanum gallate electrolyte having a dense layer and a porous layer coupled together. A solid solution of nickel oxide and an oxide, such as magnesium oxide, copper oxide, or copper magnesium oxide, is infiltrated into the porous layer. The oxide reduces the reactivity of the nickel with the lanthanum gallate electrolyte.

The present invention provides an improved hydrogen electrode for lanthanum gallate electrolyte-based electrochemical cells. The features and advantages of the present invention will become more fully apparent from the following description and appended claims, or may be learned by practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings in which:

FIG. 1 is a high-level block diagram showing the operation of a solid oxide fuel cell in accordance with the invention;

FIG. 2 is a high-level block diagram showing the operation of a solid oxide electrolyzer cell in accordance with the invention;

FIG. 3 is a high-level block diagram showing one embodiment of an electrochemical cell in accordance with the invention;

FIG. 4 is a graph showing the effects of magnesium oxide on the reactivity of nickel and LS GM;

FIG. 5 is a graph showing the relationship between cell voltage and current density for one embodiment of an electrochemical cell in accordance with the invention;

FIG. 6 is a graph showing the relationship between cell voltage and current density for electrochemical cells operated over a range of temperatures;

FIG. 7 is a magnified x-ray map showing the reactivity of nickel with the lanthanum gallate electrolyte using energy dispersive analysis;

FIG. 8 is a graph showing the performance stability of one embodiment of an electrochemical cell operated in fuel cell mode for approximately 2000 hours;

FIG. 9 is a graph showing the relationship between cell voltage, current density, and power density for one embodiment of an electrochemical cell in accordance with the invention;

FIG. 10 is a graph showing the performance stability of one embodiment of an electrochemical cell operated in fuel cell mode for approximately 4000 hours;

FIG. 11 is a graph showing the strength of lanthanum gallate under various conditions;

FIGS. 12 through 15 are various micrographs, at different levels of magnification, showing one embodiment of an oxygen electrode-supported electrochemical cell in accordance with the invention.

### DETAILED DESCRIPTION OF THE INVENTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

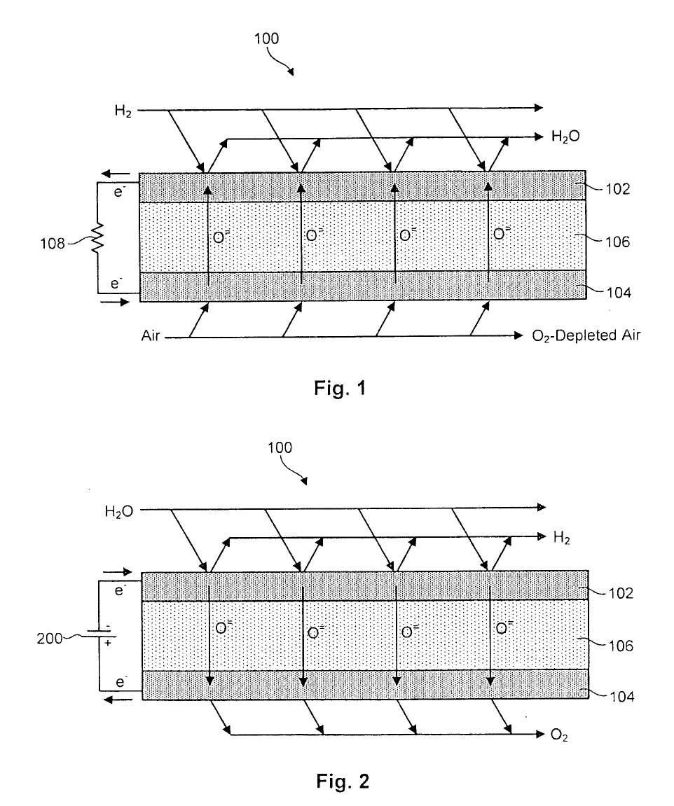

Referring to FIGS. 1 and 2, in selected embodiments, a solid oxide electrochemical cell 100 in accordance with the invention may include a hydrogen electrode 102, an oxygen electrode 104, and an electrolyte layer 106. Each of the layers 102, 104, 106 may, in certain embodiments, be composed of solid-state materials.

In selected embodiments, the solid oxide electrochemical cell 100 is reversible, meaning that it can operate as a fuel cell when current flows through the cell 100 in a first direction, and an electrolyzer cell 100 when current flows through the cell 100 in the opposite direction. Thus, the phrase “hydrogen electrode” may be used in place of the terms “anode” or “cathode” since the hydrogen electrode 102 may function as either an anode or cathode depending on the mode of operation. This name is selected because the hydrogen electrode 102 will either consume hydrogen gas, when operated in fuel mode, or generate hydrogen gas, when operated in electrolysis mode. Similarly, the phrase “oxygen electrode” may be used instead of “anode” or “cathode” since the oxygen electrode 104 may function as either an anode or cathode. The oxygen electrode 104 may either consume oxygen gas, when operated in fuel mode, or generate oxygen gas, when operated in electrolysis mode.

Referring to FIG. 1, when operating in fuel cell mode, oxygen molecules and electrons may react at the oxygen electrode 104 (in this case the cathode 104) to form oxygen ions, which may then be transported through the electrolyte 106 to the hydrogen electrode 102 (in this case the anode 102). At the hydrogen electrode 102, the oxygen ions may react with hydrogen molecules to form steam and release electrons. Because the electrolyte 106 is electrically insulating, the electrons may be conducted through an external circuit where they may drive a load 108. The electrons passing through the load 108 will again combine with oxygen gas at the oxygen electrode 104 to create additional oxygen ions, thereby completing the circuit.

Referring to FIG. 2, when operating in electrolysis mode, steam molecules and electrons (supplied by a power source 200) may react at the hydrogen electrode 102 (in this case the cathode 102) to generate oxygen ions and hydrogen gas, with hydrogen gas being the desired product. The oxygen ions may be transported through the electrolyte 106 to the oxygen electrode 104. At the oxygen electrode 104, the oxygen ions may react to form oxygen gas and electrons. These electrons may be conducted to the power source 200 to complete the circuit.

Referring to FIG. 3, as mentioned, lanthanum gallate electrolytes provide one potential solution for lowering the operating temperature of conventional SOFCs. For the purposes of this description, lanthanum gallate refers to all lanthanum gallate-based electrolytes, regardless of the dopants or other materials that are contained therein. LSGM is one example of a lanthanum gallate-based electrolyte. Lanthanum gallate compositions have higher oxygen-ion conductivity than conventional zirconia electrolytes for all operating temperatures. Lanthanum gallate electrolytes also have the advantage that they are compatible with Co-based perovskites, which are very effective for use as SOFC oxygen electrodes. Unfortunately, lanthanum gallate-based electrolytes are considered to be incompatible with nickel or nickel-based cermets, which appear to be the most effective materials studied to date for SOFC anodes, or hydrogen electrodes 102.

In selected embodiments in accordance with invention, an oxide such as magnesium oxide, copper oxide, or copper magnesium oxide may be used to increase the compatibility between nickel and lanthanum gallate-based electrolytes 106. In selected embodiments, one or more of these oxides may be finely dispersed through the nickel of the hydrogen electrode 102 to reduce the nickel's tendency to diffuse into and react with the lanthanum gallate electrolyte. In selected embodiments, the oxide may be combined with the nickel oxide to form a solid solution, creating a very fine dispersion of oxide nanoparticles throughout the nickel when the solid solution is reduced in hydrogen or other reducing gas atmosphere.

For example, magnesium oxide (MgO) may be combined with nickel oxide (NiO) to form the solid solution NiO(MgO). This solid solution may be reduced to Ni(MgO) in the presence of a reducing gas, such as hydrogen gas. That is, the NiO is reduced to metallic Ni while the MgO remains in oxide form to create the solid solution Ni(MgO). The MgO has been found to reduce the activity of Ni and thereby prevent or greatly reduce the nickel's tendency to react with lanthanum gallate to form the non-conductive reaction product lanthanum nickelate (LaNiO₃). An additional advantage of dispersing MgO through the Ni as opposed to using other oxides (e.g., copper oxide, copper magnesium oxide, etc.) listed herein is that LSGM contains a significant fraction of Mg in the structure. Thus, no additional foreign element is introduced into or placed in contact with the electrolyte 106.

In selected embodiments, the molar ratio of nickel to the additional oxide (in this example MgO) is between about 99:1 and 70:30. In other embodiments, the molar ratio is between about 95:5 and 80:20. In yet other embodiments, the molar ratio is about 90:10, which has been found to work well.

In selected embodiments, the nickel in the hydrogen electrode 102 may be mixed with a ceramic such as ceria (CeO₂) to provide various properties to the hydrogen electrode 102. There are various reasons for using ceria in the hydrogen electrode 102. First, ceria is a mixed conductor which means it is electrically conductive in addition to being a good oxygen-ion conductor. Second, ceria has a higher ionic conductivity than either zirconia-based electrolytes or LSGM. Finally, ceria has various electrocatalytic properties that facilitate the charge transfer reaction in the hydrogen electrode 102. These electrocatalytic properties are believed to be a result of ceria's oxygen non-stoichiometry, meaning it can either take up or give off oxygen rather easily.

In general, the hydrogen electrode 102 may include an ion-conducting phase (in this example ceria) to conduct oxygen ions from the electrolyte to a reaction site within the hydrogen electrode 102. The hydrogen electrode 102 may also include an electron-conducting phase (in this example the metallic nickel and also ceria under reducing conditions) to transport electrons through the electrode 102. The hydrogen electrode 102 also includes one or more electrocatalysts to facilitate the reaction. In this example, both the nickel and ceria have electrocatalytic properties that facilitate the charge transfer reaction in the hydrogen electrode 102. Finally, the hydrogen electrode 102 should be porous to allow gases to flow in and out of the electrode 102.

In selected embodiments, the oxygen electrode 104 may be fabricated from a lanthanum cobaltite composition, although it should be understood that the materials used for the oxygen electrode 104 are independent from the materials used for the hydrogen electrode 102. Thus, the hydrogen electrode 102 may be used with other types of oxygen electrodes 104 and vice versa. Where lanthanum cobaltite is used for the oxygen electrode 104, a small amount of Mg may be introduced into the lanthanum cobaltite to lower its coefficient of thermal expansion (CTE) to more closely match the CTE of the electrolyte 106. This may also lower the oxygen electrode's electrical conductivity. Because cobaltite exhibits electrical conductivity of over 1,000 S/cm, such a reduction will not significantly affect the oxygen electrode's electrical properties.

A schematic block diagram of one embodiment of an electrochemical cell 100 in accordance with the invention is illustrated. In this example, Ni(MgO) and CeO₂ are used in the hydrogen electrode 102, lanthanum gallate doped with Sr and Mg is used for the electrolyte 106, and LaSrCoMgO₃ is used for the oxygen electrode 104. As can be seen, each of the layers 102, 104, 106 may be designed to have various elements in common which can more closely match the CTE of the layers, as well as help ensure that foreign elements are not introduced from one layer to another. Nevertheless, the embodiment illustrated in FIG. 3 is intended to represent just one example of materials that may be used to implement an electrochemical cell 100 in accordance with the invention and is not intended to be limiting.

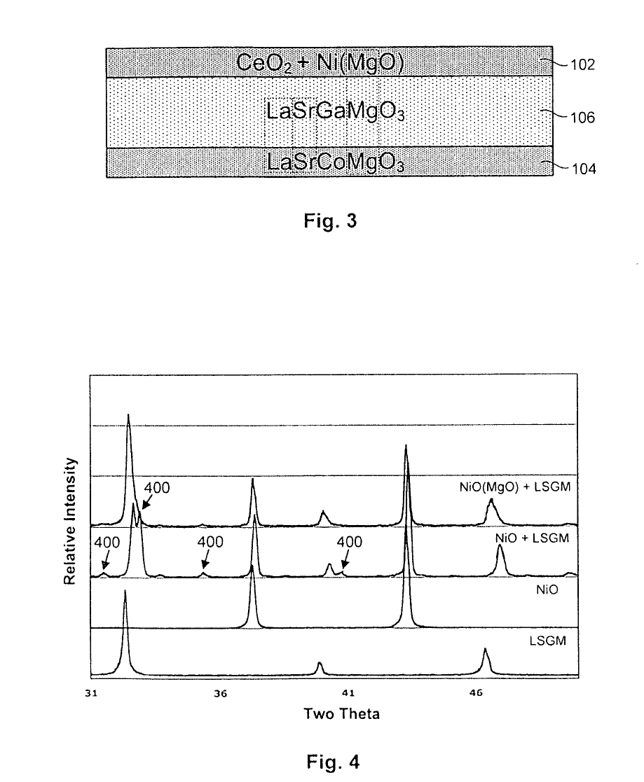

Referring to FIG. 4, a graph showing the effects of magnesium oxide on the reactivity of nickel and LSGM is illustrated. In this example, powder of a solid solution of nickel oxide and magnesium oxide NiO(MgO) having a molar ratio of approximately 90:10 was mixed with LSGM powder in a 50:50 ratio by weight and calcined at 1250° C. and 1350° C. The calcined mixture was then subjected to x-ray diffraction analysis and compared to x-ray diffraction analysis performed for NiO by itself, LSGM by itself, and NiO+LSGM. The results are illustrated in FIG. 4 and show that NiO(MgO)+LSGM showed fewer reaction products, and thus significantly better results than NiO+LSGM. In particular, various artifacts 400 were exhibited in the x-ray diffraction results for NiO+LSGM corresponding to the formation of LaNiO₃ or other unwanted reaction products that were not exhibited or very minimally exhibited for the NiO(MgO)+LSGM powder. This test shows that dispersing MgO through the Ni has the desired effect of reducing the reactivity of Ni with LS GM.

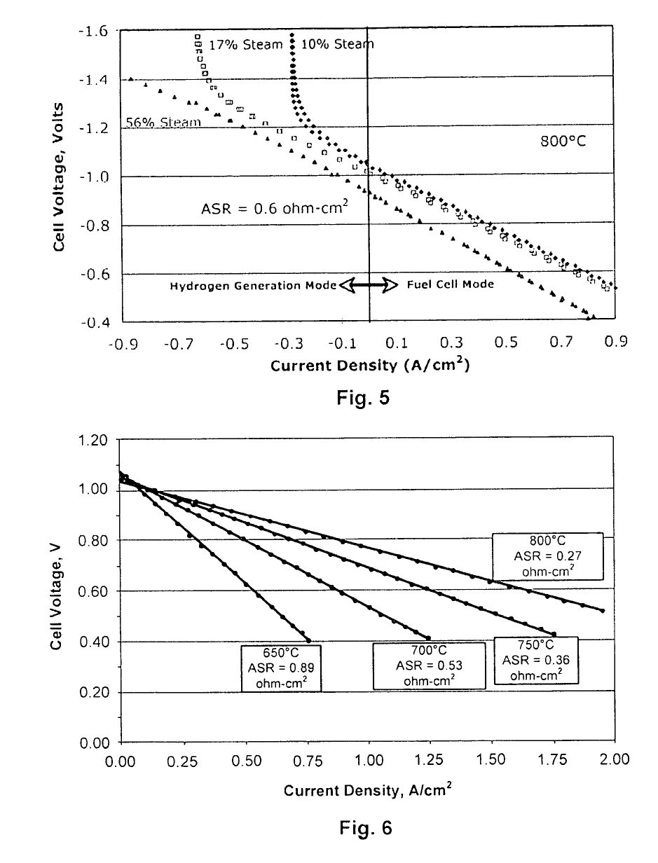

Referring to FIG. 5, a button cell was fabricated using La_{0.8}Sr_{0.2}Ga_{0.83}Mg_{0.17}O_{3-∂} as the electrolyte 106. The electrolyte 106 had a thickness of approximately 300 microns. The oxygen electrode 104 was fabricated from La_{0.8}Sr_{0.2}CoO_{3-∂} and the hydrogen electrode 102 was fabricated from a Ni(MgO)—CeO₂ cermet with a Ni to MgO molar ratio of approximately 90:10. The graph shows that the hydrogen electrode 102 had good reversibility across the open circuit voltage when transitioning from fuel cell mode to electrolysis mode (hydrogen generation mode), with a very low area specific resistance of 0.6 ohm-cm² at 800° C. Thus, the electrochemical cell 100 exhibits a similar resistance for both fuel cell and electrolysis modes. Furthermore, three different steam concentrations (10 percent, 17 percent, and 56 percent) were used to identify the effect of steam starvation on the electrochemical cell 100 when operated in electrolysis mode, as shown in FIG. 5. The non-linearity in the performance curves corresponding to the 10 percent and 17 percent steam concentrations were caused by steam starvation, as expected. These tests show that adding MgO to the Ni in the hydrogen electrode 102 does not significantly affect cell performance.

Referring to FIG. 6, a thin electrolyte (60 microns) was fabricated from porous LSGM tape and bisque-fired at 1150° C. This electrolyte was then screen printed with a high-surface-area LSGM ink and sintered at 1400° C. for 6 hours. The resulting porous LSGM substrate was then infiltrated ten times with a nickel-magnesium nitrate solution and then calcined at about 1000° C. Several cells were made using this approach. The cells were then tested using humidified hydrogen and air as the inputs. The performance curves for one of the cells are shown in FIG. 6 for different operating temperatures.

As shown, each of the performance curves is substantially linear, with each operating temperature showing a different area-specific resistance. These curves show that, even at lower operating temperatures of 650° C. and 700° C., the area-specific resistance (i.e., 0.89 and 0.53 ohm-cm² respectively) of the electrochemical cell 100 may provide adequate performance. Although the area-specific resistance may decrease at higher temperatures, the reduced area-specific resistance at lower temperatures may be offset by gains in terms of cell life, the reduced size and cost of heat exchangers, and the ability to use less expensive interconnects.

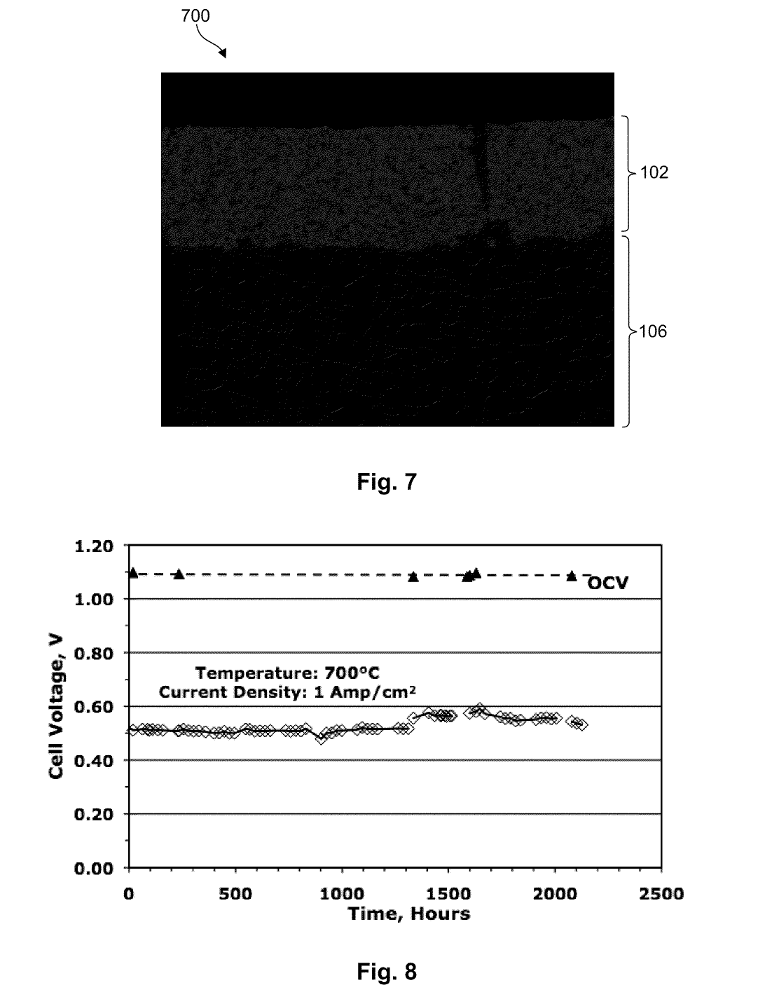

Referring to FIG. 7, a ten-by-ten centimeter stack of eight electrochemical cells 100 was operated in fuel cell mode to evaluate its long-term performance. The stack was operated for more than 1000 hours to evaluate the Ni(MgO)—CeO₂ hydrogen electrode 102 interaction with the LSGM electrolyte 106. FIG. 7 is an x-ray map 700 showing the interaction of the nickel cermet electrode 102 with the LSGM electrolyte 106 after 1200 hours of operation at 800° C. The gray areas within the x-ray map 700 indicate the presence of nickel in the hydrogen electrode 102. As can be seen from the absence of grey areas within the electrolyte layer 106, there was no indication that nickel diffused into or reacted with the LSGM electrolyte 106 after 1200 hours of operation. Thus, the fine dispersion of MgO through the nickel appeared to lower the nickel's tendency to react with the LSGM electrolyte 106.

Referring to FIG. 8, hydrogen-electrode-supported cells with a dense lanthanum gallate electrolyte layer of approximately 60 microns were tested for performance and stability when operated in fuel cell mode. An area-specific resistance of approximately 0.5 ohm-cm² was measured when the cells were operated at 700° C. This was a 100° C. reduction in operating temperature compared to electrolyte-supported designs. As shown in FIG. 8, the cell performance was stable while operating at a fairly high current density of 1 amp/cm² over a test duration of more than 2000 hours.

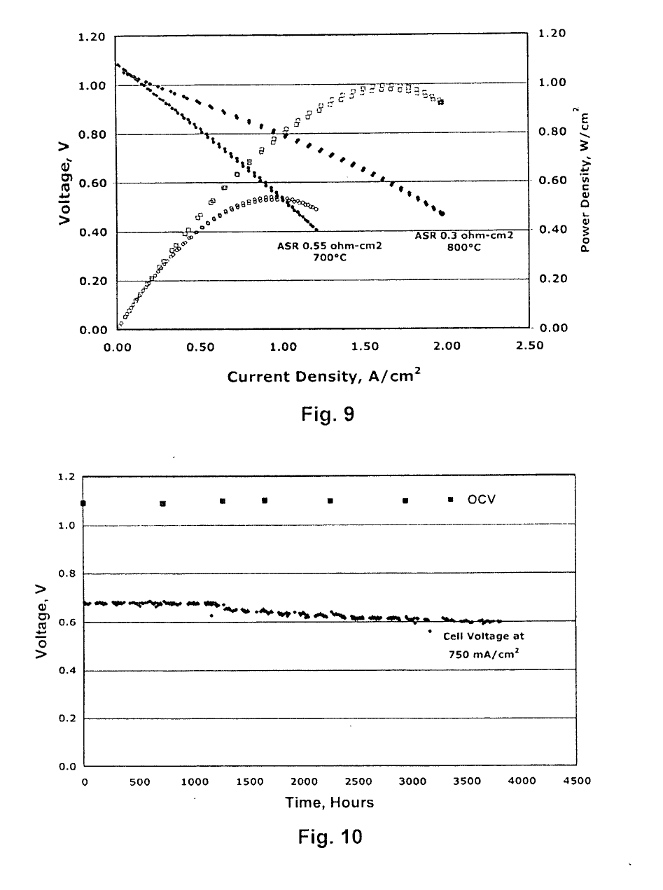

Referring to FIGS. 9 and 10, oxygen-electrode-supported cells with a dense lanthanum gallate electrolyte layer of approximately 60 microns were tested for performance and stability when operated in fuel cell mode. Their performance was similar to the hydrogen-electrode-supported cells discussed in association with FIG. 8. As shown in FIG. 9, the cells had an area-specific resistance of approximately 0.55 ohm-cm² and a power density of approximately 0.54 W/cm² when operated at 700° C. Similarly, the cells had an area-specific resistance of approximately 0.3 ohm-cm² and a power density of approximately 0.98 W/cm² when operated at 800° C. As shown in FIG. 10, the cell performance was stable at fuel utilizations of approximately 25 percent and current densities of approximately 0.75 amp/cm² over a test duration of 4000 hours.

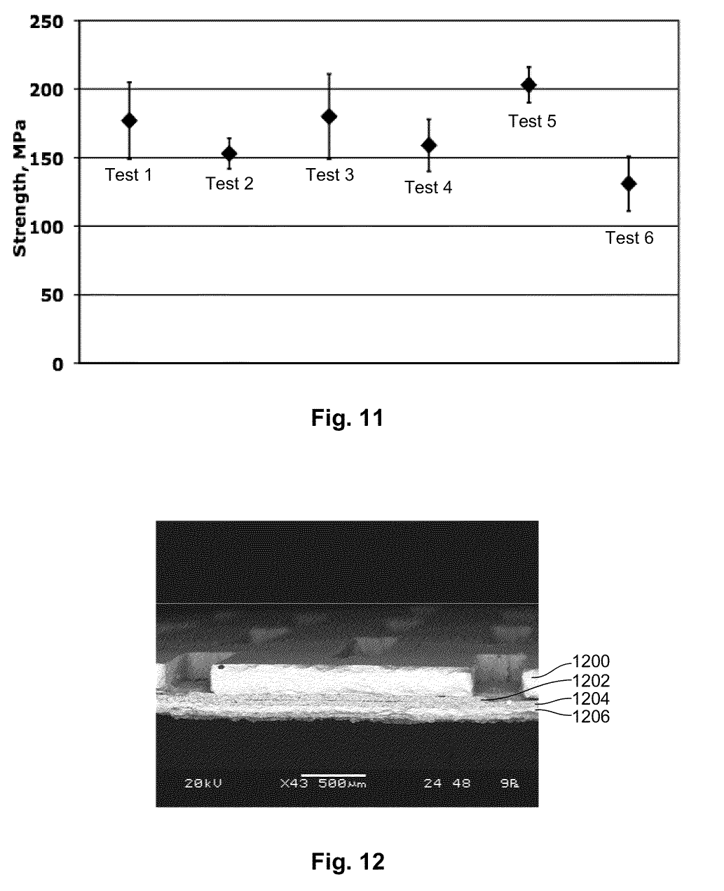

Referring to FIG. 11, the mechanical strength of the electrolyte material is often critical to the reliability of an SOFC stack. This is particularly important as thinner electrolyte layers are employed to lower the electrolyte's ohmic contribution to the cell's overall resistance. Previously published results indicate that the average strength of LSGM is about 140 MPa. It is well understood, however, that the strength of ceramic material is highly dependent on flaw size, which in turn depends on the fabrication technique.

An LSGM composition, namely La_{0.8}Sr_{0.2}Ga_{0.83}Mg_{0.17}O_{3-∂} which is reported to have very high ionic conductivity, was synthesized using a modified Pechini process, using nitrate precursors of La, Sr, Ga and Mg. Ethyelene glycol and citric acid were used to chelate the cations when heated to around 150° C. The resulting char was calcined at 1300° C. to 1400° C. to form the LSGM electrolyte material. X-ray diffraction analysis of the LSGM powder showed that it was predominantly single phase, with a minor amount of LaSrGaO₄ present in some batches. In spite of the second phase, the ionic conductivity of the synthesized LSGM, as measured in air, showed to be as high as the values reported in literature.

After fabricating the LSGM, bar samples were machined from sintered billets and, following ASTM standard techniques, four-point strength tests were performed on the synthesized LSGM at the Sandia National Lab under various conditions. In addition to performing room temperature strength tests on as-prepared samples (Test 1), tests were performed at room temperature for samples that were exposed at 800° C. in air for 100 hours (Test 2), exposed to hydrogen for 100 hours (Test 3), thermally cycled ten times in air from room temperature to 800° C. (Test 4), and thermally cycled ten times in hydrogen from room temperature to 800° C. (Test 5). Finally, as-prepared samples were also tested at 800° C. (Test 6). As shown in FIG. 11, for all conditions, the strength of the LSGM samples measured at room temperature were within the standard deviation of other treatment conditions. The strength value at 800° C. was lower, as expected, by about 25 percent.

In general, the room temperature strength values were higher than those reported in available literature. Furthermore, almost all test conditions showed the fracture origin to be internal pores or surface flaws. Thus, improvements in powder processing (reduction in agglomerate size), and fabrication (better powder packing) may provide components with fewer and smaller flaws, resulting in higher strength values. By comparison, the average room temperature strength of 8YSZ is reported to be in the range of 200 to 300 MPa.

Referring to FIGS. 12 through 15, use of a thin electrolyte layer 106 to achieve high performance typically requires that the electrolyte layer 106 be supported by a thick electrode. In the case of zirconia-electrolyte-based cells, the hydrogen electrode is typically used as the support layer since the hydrogen electrode/YSZ electrolyte bilayer can be cosintered. Initial trials using the hydrogen electrode/LSGM electrolyte bilayer approach indicate that even with the modified nickel hydrogen electrode 102 (i.e, the Ni(MgO)—CeO₂ cermet hydrogen electrode 102) the sintering temperature required for the LSGM (e.g., 1400° C. to 1500° C.) is too high to prevent interfacial reactivity between the nickel in the hydrogen electrode 102 and the LSGM electrolyte 106 (thereby forming unwanted LaNiO₃).

To prevent the formation of LaNiO₃, in selected embodiments, a laminated structure comprising a thin LSGM electrolyte layer and a porous LSGM electrolyte layer as the support may be fabricated prior to adhering the hydrogen electrode 102. To create this laminated LSGM structure, LSGM compositions may be tape-cast using conventional binders and plasticizers to provide layers of desired thicknesses. If desired, carbon black may be added to the tape as a pore former to create the porous LSGM electrolyte layer. A bilayer LSGM structure may then be fabricated by laminating the dense and porous layers using a solvent system and sintering the laminated structure at temperatures between about 1400° C. to 1500° C. for several hours (e.g., four hours).

After sintering, the porous LSGM layer may then be infiltrated with electrode precursors, such as stoichiometric mixtures of nitrate precursors of either the hydrogen electrode or oxygen electrode compositions (e.g., nickel and magnesium nitrate for the hydrogen electrode 102). In selected embodiments, several (typically five to seven) infiltrations may be needed to adequately infiltrate the porous layer with electrode material. The infiltrated bilayer structure may then be heated to about 1000° C. to 1100° C. to convert the precursors to the desired electrode compositions. In this way, the fabrication temperature for the hydrogen electrode 102 may be lowered to reduce the formation LaNiO₃. Using the above technique, an LSGM bilayer structure was created. The porous LSGM layer of this bilayer structure was then infiltrated with hydrogen electrode precursors and fired. The resulting cell had a power density greater than 0.5 W/cm² at 700° C.

In other embodiments, the cell described above may be modified to include additional layers. For example, a multilayer structure may, after sintering, include a thin dense LSGM layer supported by a continuous porous layer and one or more slotted porous layers backed by a slotted dense layer. The porous and slotted layers may then be infiltrated by either a hydrogen-electrode or oxygen-electrode slurry to create a hydrogen-electrode or oxygen-electrode-supported cell. Hydrogen-electrode-supported cells may warp slightly upon reducing the NiO in the hydrogen electrode 102 to Ni, since the phase change reduces the volume of the hydrogen electrode 102.

Because of the warpage associated with hydrogen-electrode-supported cells, it may be advantageous to use oxygen-electrode-supported designs, since the oxygen electrode material does not experience a phase change during operation. Furthermore, where a lanthanum cobaltite composition is used for the oxygen electrode, the compatibility of the lanthanum cobaltite and the lanthanum gallate may be considered beneficial in that a small amount of cobalt diffusion into the electrolyte does not change the properties of the electrolyte. The infiltration technique may also accommodate the large thermal expansion mismatch between LSGM and LSCo.

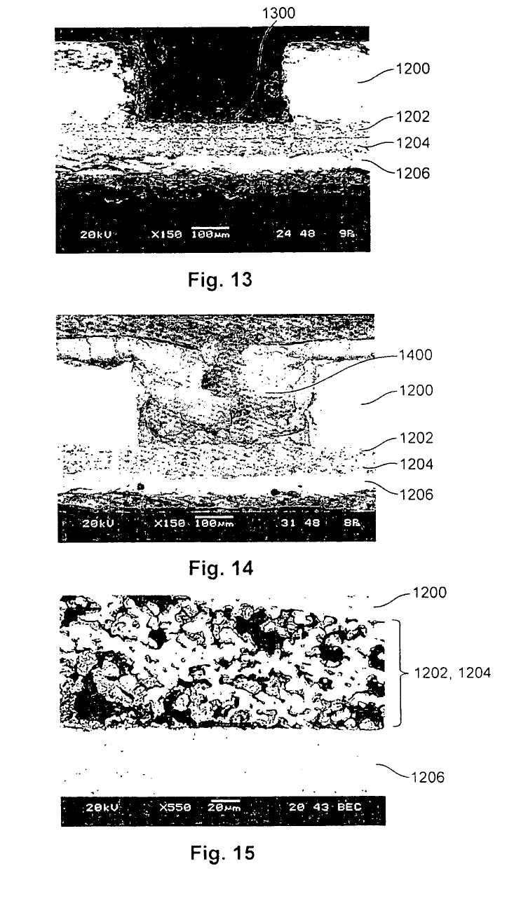

FIGS. 12 through 15 are various micrographs of an oxygen-electrode-supported cell in accordance with the invention. For example, FIGS. 12 and 13 show a fractured cross-section of one embodiment of a oxygen-electrode-supported cell having a slotted dense layer 1200 that is 200 microns thick, a first slotted porous layer 1202 that is 50 microns thick, a second slotted porous layer 1204 that is 50 microns thick, and a thin dense layer 1206 that is 75 microns thick, each layer being fabricated from LSGM. The laminated structure provides strength and rigidity to the overall package. The slotted dense layer 1200 in particular is provided exclusively for strength and rigidity purposes. The slots in the slotted dense layer 1200 allow the electrodes to be infiltrated through the slots. In this embodiment, the porous layers 1202, 1204 are infiltrated with an oxygen electrode composition, in this example a lanthanum cobaltite composition. Nevertheless, the same technique could be used to infiltrate the hydrogen electrode side of the electrochemical cell 100. In selected embodiments, a symmetric structure may be created where both the hydrogen electrode and oxygen electrode sides are infiltrated.

FIG. 13 is an enlarged view of FIG. 12 showing the slots 1300 in the porous layers 1202, 1204. FIG. 14 shows the structure of FIG. 13 after it has been screen printed with a current collection layer 1400 to fill the slots. FIG. 15 is an enlarged micrograph showing a polished cross-section of the composite oxygen electrode structure resulting from infiltrating the oxygen electrode slurry into the porous layers 1202, 1204.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An electrochemical cell comprising:
an oxygen electrode;
a solid oxide electrolyte coupled to the oxygen electrode to transport oxygen ions, the solid oxide electrolyte having a tendency to react with nickel; and
a hydrogen electrode coupled to the solid oxide electrolyte, the hydrogen electrode comprising nickel combined with a material tending to reduce the reactivity of the nickel with the solid oxide electrolyte.

2. The electrochemical cell of claim 1, wherein the solid oxide electrolyte is lanthanum gallate.

3. The electrochemical cell of claim 1, wherein the material is an oxide.

4. The electrochemical cell of claim 3, wherein the oxide is magnesium oxide.

5. The electrochemical cell of claim 4, wherein the molar ratio of nickel to magnesium oxide is between about 99:1 and 70:30.

6. The electrochemical cell of claim 4, wherein the nickel oxide and magnesium oxide form a solid solution.

7. The electrochemical cell of claim 1, wherein the material comprises at least one of copper, copper magnesium oxide and copper oxide.

8. The electrochemical cell of claim 1, wherein the material is alloyed with the nickel.

9. The electrochemical cell of claim 1, wherein the hydrogen electrode further comprises ceria.

10. The electrochemical cell of claim 1, wherein the oxygen electrode is an anode and the hydrogen electrode is a cathode.

11. The electrochemical cell of claim 1, wherein the oxygen electrode is a cathode and the hydrogen electrode is an anode.

12. The electrochemical cell of claim 1, wherein the oxygen electrode comprises lanthanum cobaltite.

13. An electrochemical cell comprising:
an oxygen electrode;
a lanthanum gallate electrolyte coupled to the oxygen electrode to transport oxygen ions; and
a hydrogen electrode coupled to the lanthanum gallate electrolyte, the hydrogen electrode comprising nickel and magnesium oxide dispersed through the nickel to reduce the reactivity of the nickel with the lanthanum gallate electrolyte.

14. The electrochemical cell of claim 13, wherein the molar ratio of nickel to magnesium oxide is between about 99:1 and 70:30.

15. The electrochemical cell of claim 13, wherein the nickel oxide and magnesium oxide form a solid solution.

16. The electrochemical cell of claim 13, wherein the hydrogen electrode further comprises a ceramic interspersed with the nickel.

17. The electrochemical cell of claim 16, wherein the ceramic is ceria.

18. The electrochemical cell of claim 13, wherein the oxygen electrode is an anode and the hydrogen electrode is a cathode.

19. The electrochemical cell of claim 13, wherein the oxygen electrode is a cathode and the hydrogen electrode is an anode.

20. A method comprising:
providing a solid oxide electrolyte;
coupling a solid solution of nickel oxide and an additional oxide to the solid oxide electrolyte;
reducing the nickel oxide to nickel while leaving the additional oxide in oxide form:
lowering the nickel's tendency to react with the solid oxide electrolyte using the additional oxide.

21. The method of claim 20, wherein the additional oxide is at least one of magnesium oxide, copper oxide, and copper magnesium oxide.

22. The method of claim 20, where the solid oxide electrolyte is lanthanum gallate.

23. An electrochemical cell comprising:
a lanthanum gallate electrolyte comprising a dense layer, substantially impermeable to gases, and a porous layer coupled to the dense layer;
a solid solution of nickel oxide and an oxide infiltrated into the porous layer, the oxide reducing the reactivity of the nickel with the lanthanum gallate electrolyte.

24. The electrochemical cell of claim 23, wherein the oxide comprises at least one of magnesium oxide, copper oxide, and copper magnesium oxide.

25. The electrochemical cell of claim 23, further comprising ceria interspersed with the solid solution.
